(19) United States
(12) Patent Application Publication
(10) Pub. No.: US 2026/0346718 A1
(43) Pub. Date: Nov. 5, 2026

(54) SYSTEMS AND METHODS FOR VEHICLE ELIGIBILITY ENGINE FOR SECURE ACCESS

(71) Applicants: FCA US LLC, Auburn Hills, MI (US); Stellantis Auto SAS, Poissy (FR)

(72) Inventors: Amit Mehta, Auburn Hills, MI (US); Abel Efrain Pech Aguilar, Auburn Hills, MI (US); Chandrasekaran Sunderajulu, Auburn Hills, MI (US)

(21) Appl. No.: 19/194,958

(22) Filed: Apr. 30, 2025

(51) Int. Cl. B60K 35/65; B60K 35/28; H04L 9/40

(52) U.S. Cl. CPC B60K 35/65; B60K 35/28; H04L 63/08; B60K 2360/1438; B60K 2360/164; B60K 2360/589; B60K 2360/731

(57) ABSTRACT

Secure authentication and user interface (UI) provisioning techniques for a vehicle include a vehicle control system transmitting authentication information including at least a vehicle identification number (VIN) to a backend system of the vehicle original equipment manufacturer (OEM) and the backend system determining a set of vehicle type parameters for the vehicle based on the authentication information, identifying a customized UI for the vehicle that corresponds to the set of vehicle type parameters, the customized UI including at least a specific listing of software applications, and selectively transmitting back update information when there have been changes to the customized UI for the vehicle compared to the preconfigured UI for the vehicle, wherein the receiving of the update information causes the vehicle control system to command the touch display of the infotainment unit to display the customized UI.

### FIELD

The present application generally relates to software applications accessible via vehicle infotainment units and, more particularly, to systems and methods for a vehicle eligibility engine for secure access.

### BACKGROUND

Today's vehicles often include infotainment units comprising touch displays that allow a customer to access and execute various software applications. These software applications can be accessible via the touch display via a specific user interface (UI) often known as an application market. Managing multi-region-based applications for a wide array of vehicle brands, models, and trims presents significant challenges for a vehicle original equipment manufacturer (OEM). This is particularly true as vehicle-specific applications become increasingly more integral to enhancing the customer experience and vehicle functionality. Conventional vehicle systems either require custom-built software application for each infotainment unit operating system (OS) or they present the same software applications (e.g., in the same order and via the same general UI) to all vehicles, regardless of the region, brand, model, and trim. Accordingly, while such conventional systems do work for their intended purpose, there exists an opportunity for improvement in the relevant art.

### SUMMARY

According to one example aspect of the invention, a secure authentication and user interface (UI) provisioning system for a vehicle is presented. In one exemplary implementation, the secure authentication and UI provisioning system comprises an infotainment system of the vehicle, the infotainment system comprising a touch display configured to display a preconfigured UI, a control system of the vehicle, the control system being configured to transmit, via a communication network, authentication information including at least a vehicle identification number (VIN) of the vehicle, and a backend system of an original equipment manufacturer (OEM) of the vehicle, the backend system being configured to receive the authentication information from the control system via the communication network, determine a set of vehicle type parameters for the vehicle based on the authentication information, identify a customized UI for the vehicle that corresponds to the set of vehicle type parameters, the customized UI including at least a specific listing of software applications, and selectively transmit, to the control system and via the communication network, update information when there have been changes to the customized UI for the vehicle compared to the preconfigured UI for the vehicle, wherein receipt of the update information causes the control system to command the touch display of the infotainment unit to display the customized UI.

In some implementations, the set of vehicle type parameters includes a brand, model, year, trim, and region of the vehicle. In some implementations, the specific listing of software applications in the customized UI includes more or fewer software applications compared to the preconfigured UI. In some implementations, the specific listing of software applications in the customized UI includes a different software application ordering compared to the preconfigured UI. In some implementations, the customized UI further includes at least one advertisement banner, and wherein the advertisement banner in the customized UI is a different advertisement banner or has a different placement in the customized UI compared to the preconfigured UI. In some implementations, the backend system is configured to receive user input to adjust a plurality of customized UIs for a plurality of different types of vehicles.

In some implementations, the backend system is configured to group at least one of multiple brands, models, years, trims, and regions into buckets corresponding to a particular customized UI of the plurality of customized UIs. In some implementations, the user input enables or disables a particular software application from being included or excluded, respectively, from a particular specific list of software applications associated with a particular customized UI. In some implementations, the communication network is a cellular data network, and wherein only providing the update information when there are differences between the customized UI and the preconfigured UI for the vehicle saves costs relative to the cellular data network compared to providing the update information to all vehicle associated with the OEM. In some implementations, the set of vehicle type parameters indicated that the vehicle is an off-road type of vehicle, and wherein the specific list of software applications for the customized UI includes an off-roading or camping type software application.

According to another example aspect of the invention, a secure authentication and UI provisioning method for a vehicle is presented. In one exemplary implementation, the secure authentication and UI provisioning system method comprises transmitting, by a control system of the vehicle and via a communication network, authentication information including at least a VIN of the vehicle, receiving, by a backend system of an OEM of the vehicle and from the control system via the communication network, the authentication information, determining, by the backend system, a set of vehicle type parameters for the vehicle based on the authentication information, identifying, by the backend system, a customized UI for the vehicle that corresponds to the set of vehicle type parameters, the customized UI including at least a specific listing of software applications, selectively transmitting, by the backend system and via the communication network, update information when there have been changes to the customized UI for the vehicle compared to the preconfigured UI for the vehicle, and receiving, by the control system and from the backend system via the communication network, the update information, wherein the receiving of the update information causes the control system to command the touch display of the infotainment unit to display the customized UI.

In some implementations, the set of vehicle type parameters includes a brand, model, year, trim, and region of the vehicle. In some implementations, the specific listing of software applications in the customized UI includes more or fewer software applications compared to the preconfigured UI. In some implementations, the specific listing of software applications in the customized UI includes a different software application ordering compared to the preconfigured UI. In some implementations, the customized UI further includes at least one advertisement banner, and wherein the advertisement banner in the customized UI is a different advertisement banner or has a different placement in the customized UI compared to the preconfigured UI. In some implementations, the backend system is configured to receive user input to adjust a plurality of customized UIs for a plurality of different types of vehicles.

In some implementations, the backend system is configured to group at least one of multiple brands, models, years, trims, and regions into buckets corresponding to a particular customized UI of the plurality of customized UIs. In some implementations, the user input enables or disables a particular software application from being included or excluded, respectively, from a particular specific list of software applications associated with a particular customized UI. In some implementations, the communication network is a cellular data network, and wherein only providing the update information when there are differences between the customized UI and the preconfigured UI for the vehicle saves costs relative to the cellular data network compared to providing the update information to all vehicle associated with the OEM. In some implementations, the set of vehicle type parameters indicated that the vehicle is an off-road type of vehicle, and wherein the specific list of software applications for the customized UI includes an off-roading or camping type software application.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having an example secure authentication and user interface (UI) provisioning system according to the principles of the present application;

FIG. 2A is a functional block diagram of an example system architecture for the secure communication and user UI provisioning system according to the principles of the present application;

FIG. 2B is a diagram of an example UI that is customizable and providable by the secure communication and UI provisioning system according to the principles of the present application;

FIG. 3A is a flow diagram of an example secure authentication and UI provisioning method for an original equipment manufacturer (OEM) vehicle according to the principles of the present application; and

FIG. 3B is a flow diagram of an example OEM backend system-based user adjustment method for customized UIs for OEM vehicles according to the principles of the present application.

### DESCRIPTION

As discussed above, today's vehicles often include infotainment units comprising touch displays that allow a customer to access and execute various software applications. These software applications can be accessible via the touch display via a specific user interface (UI) often known as an application market. Managing multi-region-based applications for a wide array of vehicle brands, models, and trims presents significant challenges for a vehicle original equipment manufacturer (OEM). This is particularly true as vehicle-specific applications become increasingly more integral to enhancing the customer experience and vehicle functionality. Conventional vehicle systems either require custom-built software application for each infotainment unit operating system (OS) or they present the same software applications (e.g., in the same order and via the same general UI) to all vehicles, regardless of the region, brand, model, and trim. In addition to increased cellular data network costs to update every OEM vehicle with the same UI, these conventional solutions lack any user experience (UX) diversity or optimization and also can suffer from certain software applications not functioning the same, and sometimes malfunctioning, across different vehicles. Thus, while such conventional systems do work for their intended purpose, there exists an opportunity for improvement in the relevant art.

Accordingly, improved secure authentication, communication, and UI provisioning systems and methods for vehicles of an OEM are presented herein. These techniques initially perform a secure access procedure based on the vehicle identification number (VIN), which also identifies the region/model/brand/trim of the vehicle. In response, the vehicle is provided with a customized application layout as defined by engineers/developers on a backend OEM system (e.g., a system of server computing devices). As an example, specific applications can be enabled/disabled or have features enabled/disabled, and the overall UI (e.g., including advertisements/banners) could be customized for different groups of regions/brands/models/trims of vehicles. For example, only certain vehicles capable of off-roading could be provided with a UI including an off-roading or camping software application, whereas other vehicles may not receive/display the same software application. Potential benefits include easier/faster management of UI updates by the OEM, reduced cellular data network costs for the OEM, easier/faster software deployment by third-party software application developers (e.g., identifying software application malfunctions and disabling or fixing the corresponding problems), and general UI/UX customization and thus an overall improved customer experience.

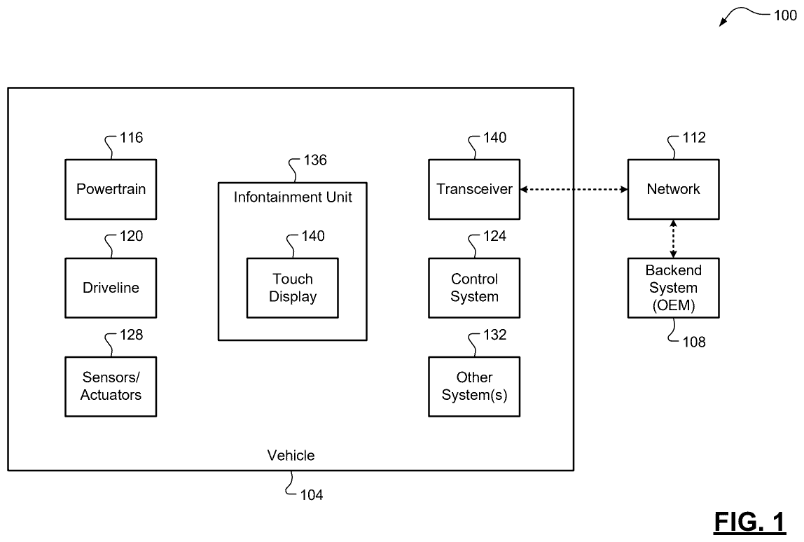

Referring now to FIG. 1, a functional block diagram of an example secure authentication and UI provisioning system 100 for a vehicle 104 of an OEM according to the principles of the present application is illustrated. The secure authentication and UI provisioning system 100 further comprises a backend system 108 (associated with the same OEM as the vehicle 104, also “OEM vehicle 104” herein) that is configured to communicate with the vehicle 104 via a communication network 112 (also “network 112” herein). The backend system 108 could be, for example, a system of one or more computing servers and thus could also be described as a cloud-based system. In one embodiment, network 112 is a cellular communication or cellular data network that has specific charges per unit of transmitted data (e.g., per gigabyte, or GB). The vehicle 104 further comprises a powertrain 116 configured to generate and transfer drive torque to a driveline 120 for propulsion. Non-limiting examples of components of the powertrain 116 include an internal combustion engine, an electric traction motor and a high voltage battery pack or system, and a transmission, gearbox, or gear reducer. Non-limiting examples of components of the driveline 120 include a differential, axles or half-shafts, and wheels/hubs.

A controller or control system 124 controls the operation of the vehicle 100, which primarily involves controlling the powertrain 116 to generate a desired amount of drive torque to satisfy a driver torque request. The driver torque request could be provided, for example, via an accelerator pedal, which can be one of a plurality of sensors/actuators 128 that are used for control of the components of the vehicle 104, the above-described systems (e.g., the powertrain 116), as well as other systems 132 that are not specifically illustrated or described herein (e.g., autonomous driving or advanced driver assistance, or ADAS, systems). The vehicle 104 further comprises an infotainment system or unit 136, which comprises a touch display 140 for displaying a UI to occupant(s) of the vehicle 104 and is controlled by its own internal controller or the control system 124. While a touch display 140 is specifically shown and described herein, it will be appreciated that the techniques of the present application could be applicable to non-touch displays having separate controls/buttons for actuation. The control system 124 is also configured to execute at least a portion of the secure authentication and UI provisioning techniques of the present application, which can involve the use of a communication transceiver 140 (also “transceiver 140” herein) for communication via the network 112.

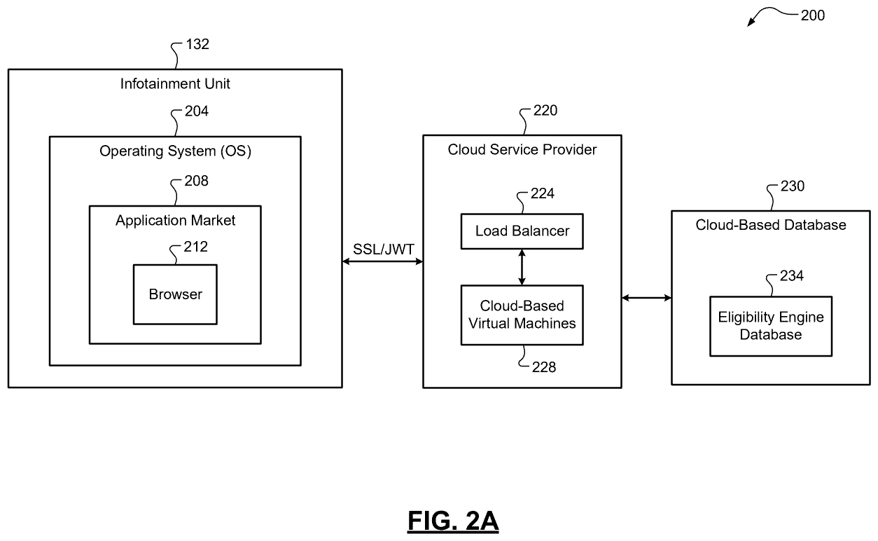

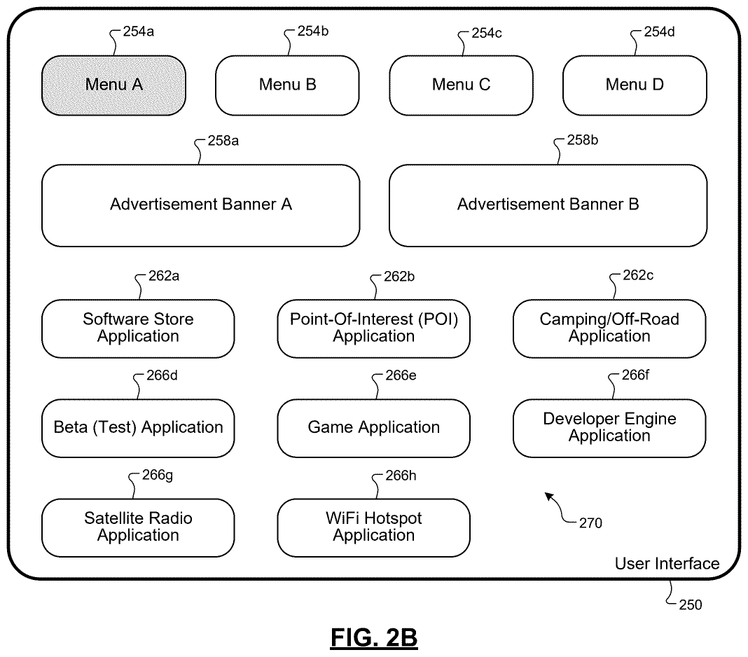

Referring now to FIG. 2A and with continued reference to FIG. 1, a functional block diagram of an example system architecture 200 for the secure authentication and UI provisioning system 100 according to the principles of the present application is illustrated. FIG. 2A provides a high-level design architecture of the eligibility engine and how it interacts with various components. The following is a step-by-step explanation of an example flow. Within the infotainment unit 136 (or, more specifically, its internal controller or the control system 124), there is an operating system (OS) 204, which could a version of the device or system OS. The OS 204 executes an application market software application 208 and a browser application 212 that is used to interact with the eligibility engine. The customer accesses services via this interface. FIG. 2A further includes a cloud service provider 220 and a cloud-based database 230, which could be sub-systems of the backend system 108 of FIG. 1. The OS 204 communicates with the cloud service provider 220 to handle backend services. This secure encrypted communication between the infotainment unit 132 (i.e., the OS 204) and the cloud service provider 220 could involve a secure sockets layer (SSL) and JavaScript Object Notation (JSON) web token (JWT) exchanging. One key component of the cloud service provider 220 is a load balancer 224, which is configured to ensure that requests are efficiently distributed across multiple servers to optimize performance and availability.

Other key component(s) of the cloud service provider 220 are cloud-based virtual machines 228, which are configured to host the backend infrastructure, including a server running the eligibility engine application. The eligibility engine processes incoming requests from the infotainment unit 136 (via the load balancer 224) and performs various operations, such as vehicle registration, subscription, and determining application eligibility. The eligibility engine stores and retrieves all necessary data in the cloud-based database 230 and, more specifically, an eligibility engine database 234. This database 234 contains, for example, vehicle registration data, subscription information, metadata, and application eligibility rules. To summarize, the vehicle infotainment unit 136 initiates requests (e.g., for VIN, brand, and software application or “app” eligibility). These requests are routed through the load balancer 224 for proper distribution. The eligibility engine running on the server(s) 228 (e.g., an Apache Tomcat® server) processes the requests, interacts with the database, and determines eligible applications. The results are sent back to the infotainment unit 136, allowing customers (e.g., vehicle occupants) to view and interact with the available software applications. This architecture 200 ensures scalability, availability, and smooth communication between the vehicle system, cloud-based application logic, and the database(s).

Referring now to FIG. 2B and with continued reference to the previous figures, a diagram of an example UI 250 customizable and providable by the secure authentication and UI provisioning system 100 according to the principles of the present application is illustrated. As shown, the UI 250 includes an upper row of menu elements 254a-254d (“menu elements 254”). Non-limiting examples of these menu elements 254 include a user-personalized or “For You” menu (with corresponding Menu A 254a being selected), an entertainment menu, an adventure menu, and a convenience menu. The UI 250 can also optionally include one or more advertisement banners, illustrated as advertisement banner elements 258a-258b (“advertisement banner elements 258”). These advertisement banner elements 258 could each display advertisements (e.g., text, images, or combinations thereof), and could be associated with the OEM (e.g., a performance parts division of the OEM) and/or with non-OEM (third-party) companies and can be selectable by the customer to link or send them to another site (e.g., to make a payment or to download a particular software application). These advertisement banners 258 thus can provide a potential source of additional revenue for the OEM of the vehicle 104.

The UI 250 also includes a plurality of software application elements 262a-262h (“software application elements 262”) each representing a link or a launch command for a respective software application (also commonly referred to as “apps,” “widgets,” or “web widgets”). As shown, software application elements 262 are arranged in a specific order or list 270, which is generally prioritized from top to bottom and from left to right as a typical customer would read. Non-limiting examples of the software applications include a software store software application, a point-of-interest (POI) software application, a camping or off-roading (trail) software application, a beta (test version) software application, a game software application, a developer engine software application, a satellite radio software application, and a Wifi hotspot software application. It will be appreciated that this is merely one example configuration or version of the UI 250 displayable by the touch display 140 of the infotainment unit 136 of the vehicle 104 and should not limit the scope of the term “UI” as used herein. One primary function of the UI updating via the backend system 108 is the capability of the OEM (i.e., a designer or engineer) to quickly and easily add/remove and/or reorder/reprioritize the plurality of software applications as they are arranged in the list 270 of a particular customized UI (e.g., UI 250) for various different regions/brands/models/trims of OEM vehicles.

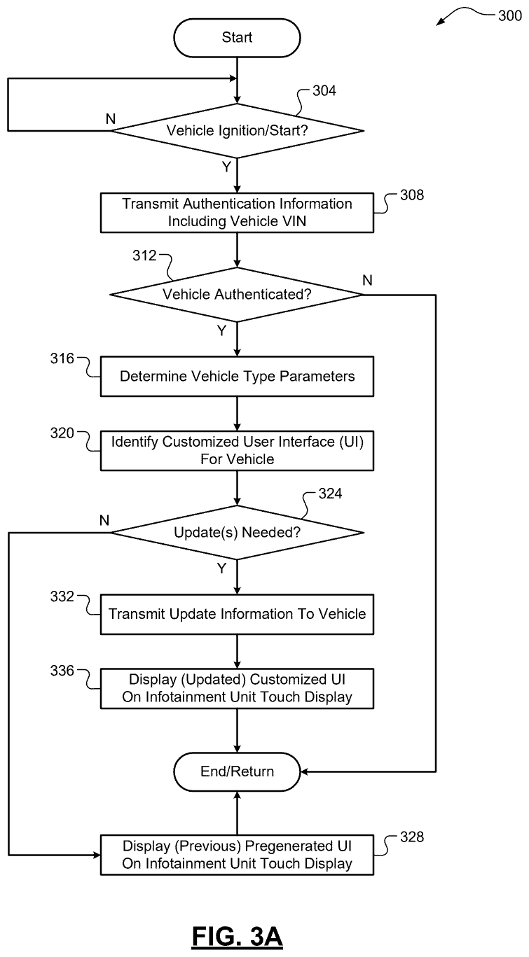

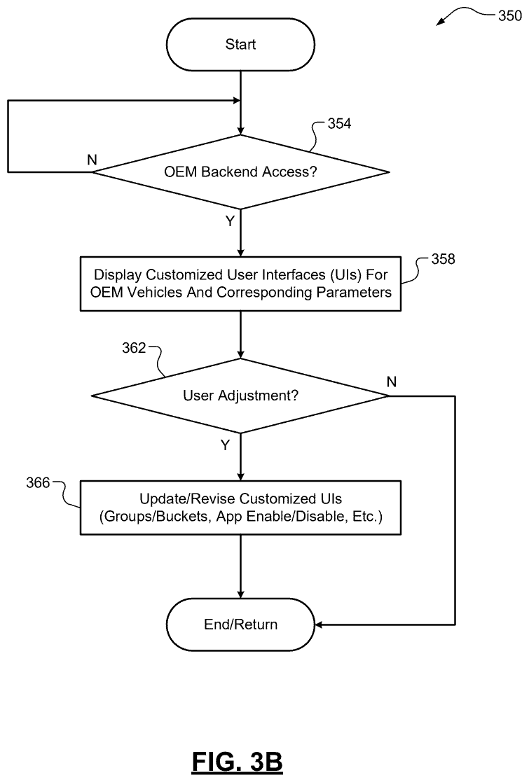

Referring now to FIG. 3A and with continued reference to the previous figures, an example secure authentication and UI provisioning method 300 (also “method 300” herein”) for an OEM vehicle according to the principles of the present application is illustrated. While the method 300 specifically references the OEM vehicle 104 and other components previously illustrated and/or described herein for descriptive and illustrative purposes, it will be appreciated that the method 300 could be applicable to any suitably configured OEM vehicle and OEM backend system. The method 300 begins at 304 where the control system 124 determines whether an ignition or key-on cycle of the vehicle 104 has been initiated (e.g., via one of the sensors/actuators 128). When true, the method 300 proceeds to 308. When false, the method 300 ends or returns to 304. While shown to occur upon every key cycle of the vehicle 104, it will be appreciated that the method 300 could also be executed at other intervals, such as predetermined intervals (daily, weekly, etc.) or in response to other conditions (e.g., a broadcast or notification from the OEM backend system 108). At 308, the control system 124 transmits, via the network 112 and using the transceiver 140, authentication information to the OEM backend system 108. The authentication information includes at least a VIN (also known as a “chassis number” or “frame number”) of the vehicle 104, which is a unique alphanumeric number assigned to every vehicle (automobiles, motorcycles, etc.) as defined by the International Organization for Standardization (ISO) in ISO 3779 and ISO 4030.

At 312, the OEM backend system 108 determines, based on the authentication information, whether the vehicle 104 is authenticated. For example, there could be instances where unauthorized requests are received from non-OEM vehicles having VINs that would not be authenticated. When not authenticated, the method 300 ends. When authenticated (e.g., when the VIN indicates that the vehicle 104 is manufactured by the OEM), the method 300 proceeds to 316. At 316, from the VIN, the OEM backend system 108 is able to extract vehicle type parameters including, but not limited to, region (North American, Europe, Asia, etc.), brand, model (e.g., of each particular brand), and trim level (e.g., of each particular model). While regions are often described as continent-based regions herein, it would be appreciated if the regional information could be further divided into specific countries or country groupings (e.g., based on country codes). As examples only, the VIN could indicate Region A, Brand A, Model A, and Trim Level B or (ii) Region B, Brand B, Model C, and Trim Level A. It will be appreciated that the authentication information could include other information in addition to the VIN, such as a personal identifier for the customer (e.g., a driver that is currently in the vehicle 104 and that is detected, such as by camera or key fob, or that is logged into an OEM user account via the infotainment unit 136).

The authentication information could also include or indicate a current version or revision/update date of the current (or “preconfigured”) UI displayable/displayed at the touch display 140 of the infotainment system 132. The OEM backend system 108 can perform filtering of the larger database of information to display only relevant information to the particular vehicle 104 in a UI at the OEM backend system 108, which is discussed in more detail below in reference to FIG. 3B. For example, some information (e.g., software applications) may not be relevant to a current customized UI for the particular vehicle 104 and thus it could not be displayed or could be “greyed-out” or otherwise indicated as not being relevant or currently active/selected. There can also be user interaction or adjustment of the customized UIs or various groupings as discussed in more detail below in reference to FIG. 3B. At 320, based on the extracted or determined vehicle type parameters, the OEM backend system 108 identifies a customized UI for the particular vehicle 104. This customized UI could, for example, have a version or a revision/update date associated therewith (e.g., indicating when the customized UI was last revised/updated).

At 324, the OEM backend system 108 determines whether an update is needed for the current UI at the vehicle 104. This could involve, for example, determining whether the version or revision/update date of the current UI at the vehicle 104 is the same as the customized UI identified at the OEM backend system 108. When no update is needed, the method 300 proceeds to 328 where the current UI continues to be used by the touch display 140 of the infotainment unit 136 of the vehicle and the method 300 then ends. In such cases, the OEM can save costs (e.g., for cellular data network transmissions) by not providing any unnecessary update data. When an update is needed, however, method 300 proceeds to 332. At 332, the OEM backend system 108 transmits updated information to vehicle 104 (i.e., to the control system 124 via the network 112 and the transceiver 140). This updated information may not include a full customized UI but instead could include only minor instructional changes (e.g., for the customized UI to reorder existing apps, such as in list 270, compared to the previous UI) or only some new JavaScript (JSON) objects for display (software application icons, advertisement banner text/images, etc.). At 336, the control system 124 controls the infotainment unit 136 to display the customized UI at the touch display 140 and the method 300 ends.

Referring now to FIG. 3B and with continued reference to the previous figures, a flow diagram of an example OEM backend system-based user adjustment method 350 (also “method “350” herein) for customized UIs for OEM vehicles according to the principles of the present application is illustrated. At 354, the OEM backend system 108 can determine whether a requesting user (a developer, an engineer, etc.) is authorized to access the OEM backend system. This could involve, for example, a unique username/password, a two-factor type authentication, or any other suitable authentication process to ensure that unauthorized third parties are not able to access the OEM backend system 108. When the user is not authenticated, the method 350 ends. When the user is authenticated, method 350 proceeds to 358. At 358, the OEM backend system 108 displays its own UI, which could be details about various software applications and their inclusion/exclusion from various customized UIs for various OEM vehicles. While the specific UI is not shown herein because it is proprietary, the general appearance and functionality of the UI displayed and utilized at the OEM backend system 108 will be described in more detail below. It will be appreciated that these are merely example appearance/function features and that the OEM backend system 108 could function in generally the same manner while utilizing various different UIs than those specifically described herein.

In one exemplary embodiment, each software application displayed in the current UI of the OEM backend system 108 can have the following information or parameters: (1) application name and identifier, (2) geographical regions associated therewith or with each particular software application (e.g., in a first colored label), (3) OEM brands associated therewith (e.g., in a different second colored label), (4) OEM models associated therewith (e.g., in a different third colored label), and (5) OEM trims or trim levels associated therewith (e.g., in a different fourth colored label). Other possible information or parameters associated with each particular software application include (6) OEM devices (e.g., infotainment unit models) associated therewith (e.g., in a fifth different color) and (7) services (free, paid, etc.) associated therewith (e.g., in a sixth different color). A particular OEM could also use specific codes/names/identifiers (IDs) for various brands/models/trims (e.g., brand AB, model BC, and trim XY). From this UI displayed by the OEM backend system 108, the user is able to perform various adjustment actions at step 362 including, but not limited to, for each software application of a particular customized UI (for a particular OEM vehicle or group of OEM vehicles): (1) enabling/disabling the software application, (2) changing a status (e.g., free vs. paid) of the software application, and (3) changing or reordering/reprioritizing the list 270 of the software applications of the customized UI. At 366, the adjustments are made and the customized UIs stored by and then made providable from the OEM backend system 108 to OEM vehicles 104.

Selective grouping or “bucketing” of software applications as being included in the customized UIs for multiple regions/brands/models/trims of the OEM vehicles also enables faster/easier viewing and adjustment by the user via the backend system 108. For example only, certain OEM vehicles that are sport-utility type or off-road capable vehicles could each have customized UIs that include a camping/off-road (trail) app, such as software application element 262c of FIG. 2B, whereas other OEM vehicles or a remainder of the OEM vehicles that do not share those same features/capabilities may not receive customized UIs with such a software application included therein as it could be considered irrelevant or not useful to those consumers of those other OEM vehicles. This also allows for the OEM and its third-party software application developers and third-party advertisers to uniquely target or offer specific software applications and services to certain customers of certain OEM vehicles, while also not bothering or annoying other customers of other OEM vehicles that would likely be disinterested in those same software applications and services. In yet another aspect, this allows for easier debugging of existing or test (beta) versions of software applications by the OEM and/or third-party developers as certain test/beta software applications could only be enabled and provided to the customized UIs of certain OEM test vehicles, thereby allowing for real-world testing of software applications and other features or functionality without providing the software application to the general public.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

1. A secure authentication and user interface (UI) provisioning system for a vehicle, the secure authentication and UI provisioning system comprising:
an infotainment system of the vehicle, the infotainment system comprising a touch display configured to display a preconfigured UI;
a control system of the vehicle, the control system being configured to transmit, via a communication network, authentication information including at least a vehicle identification number (VIN) of the vehicle; and
a backend system of an original equipment manufacturer (OEM) of the vehicle, the backend system being configured to:
receive the authentication information from the control system via the communication network;
determine a set of vehicle type parameters for the vehicle based on the authentication information, wherein the set of vehicle type parameters includes a brand, model, year, trim, and region of the vehicle as derived from the VIN;
identify a customized UI for the vehicle that corresponds to the set of vehicle type parameters by matching the set of vehicle type parameters to one of a plurality of customized UIs associated with a plurality of different groups of vehicle type parameters, the customized UI including at least a specific listing of software applications that is different than a specific listing of software applications in the preconfigured UI in at least one of application content, application ordering, and application quantity; and
selectively transmit, to the control system and via the communication network, update information only when there have been changes to the customized UI for the vehicle compared to the preconfigured UI for the vehicle,
wherein receipt of the update information causes the control system to command the touch display of the infotainment unit to display the customized UI.

2. (canceled)

3. The secure authentication and UI provisioning system of claim 1, wherein the specific listing of software applications in the customized UI includes more or fewer software applications compared to the preconfigured UI.

4. The secure authentication and UI provisioning system of claim 1, wherein the specific listing of software applications in the customized UI includes a different software application ordering compared to the preconfigured UI.

5. The secure authentication and UI provisioning system of claim 1, wherein the customized UI further includes at least one advertisement banner, and wherein the advertisement banner in the customized UI is a different advertisement banner or has a different placement in the customized UI compared to the preconfigured UI.

6. The secure authentication and UI provisioning system of claim 1, wherein the backend system is configured to receive user input to adjust a plurality of customized UIs for a plurality of different types of vehicles.

7. The secure authentication and UI provisioning system of claim 6, wherein the backend system is configured to group at least one of multiple brands, models, years, trims, and regions into buckets corresponding to a particular customized UI of the plurality of customized UIs.

8. The secure authentication and UI provisioning system of claim 7, wherein the user input enables or disables a particular software application from being included or excluded, respectively, from a particular specific list of software applications associated with a particular customized UI.

9. The secure authentication and UI provisioning system of claim 1, wherein the communication network is a cellular data network, and wherein only providing the update information when there are differences between the customized UI and the preconfigured UI for the vehicle saves costs relative to the cellular data network compared to providing the update information to all vehicle associated with the OEM.

10. The secure authentication and UI provisioning system of claim 1, wherein the set of vehicle type parameters indicated that the vehicle is an off-road type of vehicle, and wherein the specific list of software applications for the customized UI includes an off-roading or camping type software application.

11. A secure authentication and user interface (UI) provisioning method for a vehicle, the secure authentication and UI provisioning system method comprising:
transmitting, by a control system of the vehicle and via a communication network, authentication information including at least a vehicle identification number (VIN) of the vehicle;
receiving, by a backend system of an original equipment manufacturer (OEM) of the vehicle and from the control system via the communication network, the authentication information;
determining, by the backend system, a set of vehicle type parameters for the vehicle based on the authentication information, wherein the set of vehicle type parameters includes a brand, model, year, trim, and region of the vehicle as derived from the VIN;
identifying, by the backend system, a customized UI for the vehicle that corresponds to the set of vehicle type parameters by matching the set of vehicle type parameters to one of a plurality of customized UIs associated with a plurality of different groups of vehicle type parameters, the customized UI including at least a specific listing of software applications that is different than a specific listing of software applications in the preconfigured UI in at least one of application content, application ordering, and application quantity;
selectively transmitting, by the backend system and via the communication network, update information only when there have been changes to the customized UI for the vehicle compared to the preconfigured UI for the vehicle; and
receiving, by the control system and from the backend system via the communication network, the update information, wherein the receiving of the update information causes the control system to command the touch display of the infotainment unit to display the customized UI.

12. (canceled)

13. The secure authentication and UI provisioning method of claim 11, wherein the specific listing of software applications in the customized UI includes more or fewer software applications compared to the preconfigured UI.

14. The secure authentication and UI provisioning method of claim 11, wherein the specific listing of software applications in the customized UI includes a different software application ordering compared to the preconfigured UI.

15. The secure authentication and UI provisioning method of claim 11, wherein the customized UI further includes at least one advertisement banner, and wherein the advertisement banner in the customized UI is a different advertisement banner or has a different placement in the customized UI compared to the preconfigured UI.

16. The secure authentication and UI provisioning method of claim 11, wherein the backend system is configured to receive user input to adjust a plurality of customized UIs for a plurality of different types of vehicles.

17. The secure authentication and UI provisioning method of claim 16, wherein the backend system is configured to group at least one of multiple brands, models, years, trims, and regions into buckets corresponding to a particular customized UI of the plurality of customized UIs.

18. The secure authentication and UI provisioning method of claim 17, wherein the user input enables or disables a particular software application from being included or excluded, respectively, from a particular specific list of software applications associated with a particular customized UI.

19. The secure authentication and UI provisioning method of claim 11, wherein the communication network is a cellular data network, and wherein only providing the update information when there are differences between the customized UI and the preconfigured UI for the vehicle saves costs relative to the cellular data network compared to providing the update information to all vehicle associated with the OEM.

20. The secure authentication and UI provisioning method of claim 11, wherein the set of vehicle type parameters indicated that the vehicle is an off-road type of vehicle, and wherein the specific list of software applications for the customized UI includes an off-roading or camping type software application.
